(19) United States
(12) Patent Application Publication
(10) Pub. No.: US 2014/0162072 A1
(43) Pub. Date: Jun. 12, 2014

(54) THERMOSETTING RESIN COMPOSITIONS, RESIN FILMS IN B-STAGE, METAL FOILS, COPPER CLAD BOARDS AND MULTI LAYER BUILD-UP BOARDS

(71) Applicant: TAMURA CORPORATION, Tokyo (JP)

(72) Inventors: Tetsuaki SUZUKI, Iruma-shi (JP); Yusuke TANAHASHI, Iruma-shi (JP); Nobuaki ISHIZAKA, Iruma-shi (JP)

(73) Assignee: TAMURA CORPORATION, Tokyo (JP)

(21) Appl. No.: 13/708,370

(22) Filed: Dec. 7, 2012

(51) Int. Cl. C08L 63/00

(52) U.S. Cl. CPC C08L 63/00
USPC 428/418; 525/418; 523/445; 523/457; 523/466

(57) ABSTRACT

A thermosetting resin composition contains a liquid epoxy resin, a solid epoxy resin having a softening point of 125° C. or lower, an aromatic diamine compound including benzoate group and a main chain including polymethylene group, a solvent soluble polyimide resin having Tg of 200° C. or higher and a weight average molecular weight Mw of 50000 or smaller, and a phenoxy resin having Tg of 130° C. or higher. A total of amounts of the solvent soluble polyamide resin and the phenoxy resin is 15 weight parts or more and 150 weight parts or less, provided that 100 weight parts are assigned to a total of amounts of the liquid epoxy resin, the solid epoxy resin and the aromatic diamine compound.

### BACKGROUND OF THE INVENTION

1. Technical Field

The present invention relates to a thermosetting resin composition and a resin film in B-stage produced by using the resin composition. The resin composition may be applied for an adhesive, a prepreg, a paint or the like, as a base material for a flexible board and for a build-up board with a core material mainly composed of a flexible base and a metal base board with a base material composed of aluminum or the like. The present invention further relates to a metal foil with an adhesive and a copper-clad board or the like having the B-stage film obtained by applying the resin composition on one surface of the metal foil. The present invention may thus be used for a high-density flexible build-up print wiring board, one-shot molding board and heat dissipation board which are flexible, has high resistance against heat, high adhesive strength and reliability. The thus obtained print wiring board may be applied for mobile apparatuses, LED boards, module boards or the like.

2. Related Art Statement

Recently, as can been seen from higher functionality of mobile phones and thinning represented by liquid crystal displays, it has been demanded thinning, as well as higher functionality, in print circuit boards and module boards used for such appliances. In such print circuit boards, it has been used a flexible print wiring board has been used as a part of them.

According to prior arts, as materials for such flexible boards without a base, it has been generally used a rubber and a thermosetting resin, or an adhesive of an epoxy resin modified with a phenoxy resin or the like as its bonding sheet other than polyimide resin base materials. These materials have been also used for a copper clad board and a cover lay. These materials, however, generally have a low Tg and the reliability is inferior than rigid materials.

Further, these adhesives are often excellent in its adhesive strength with another kind of material, so that they have been used as an adhesive for a metal base board. The metal base, however, does not contain pure aluminum, so that its adhesion requires troublesome alumite treatment. Pure aluminum is excellent in its flexibility and thus suitable for the metal base board requiring flexible wiring.

In rigid type materials, prepreg, resin film or RCC has been used for producing multi-layered structure or build-up board. In contrast to this, for attaining higher density and thinning of a flexible print wiring board, it has been attained a multi-layered structure by combinations of both surface FPC and both surface FPC, single surface FPC and single surface FPC and single surface FPC and both surface FPC. Further, the higher density and thinning have been attained by the structures or production methods. Although it has been known to try the improvement of the characteristics by the material itself, it has not been attained the improvement in its reliability and workability. For example, the following patent documents 1 to 7 disclose such specific examples. As one of the reasons of the problems as described above, it has not been found yet a material corresponding with a build-up material, such as the resin film or RCC, used in the rigid type boards.

Further, the applicant filed Patent document 8 and disclosed a thermosetting resin composition containing a liquid epoxy resin, solid epoxy resin, triazine modified phenol novolak resin solidifier and a solvent soluble polyimide resin, mainly for use as a rigid material. Further, the applicant filed Patent document 9 and disclosed a thermosetting resin composition containing a liquid epoxy resin, solid epoxy resin, triazine-modified phenol novolak resin, benzoxazine resin and a phenoxy resin having Tg of 120° C. or higher, mainly for use as a rigid material.
(Patent document 1) WO 2007/046459 A
(Patent document 2) Japanese Patent No. 4237726 B
(Patent document 3) Japanese Patent Publication No. 2005-126543A
(Patent document 4) Japanese Patent Publication No. 2005-847414A
(Patent document 5) Japanese Patent Publication No. 2006-299209A
(Patent document 6) Japanese Patent Publication No. 2006-179679A
(Patent document 7) Japanese Patent Publication No. 2011-040607A
(Patent document 8) Japanese Patent Publication No. 2007-224242A
(Patent document 9) Japanese Patent Publication No. 2008-037957A

### SUMMARY OF THE INVENTION

As described above, except a copper clad board composed of polyimide resin only as to the material, it has not been known such board satisfying workability and reliability demanded in the art in addition to the bending characteristics, small thickness and low weight.

Further, it has not been known an appropriate material suitable for the build-up material for use in the flexible circuit board composed of polyimide resin only.

As described above, it has not been known a material satisfying the demands described above. Specifically, it has not been known an epoxy material for a flexible circuit board having reliability and workability comparable with those of halogen-free FR-4, as well as the flexibility and insulating property at a small thickness required for the material for use in the flexible board. The workability herein referred to is indispensable in applications of high density mount board and build-up board. For example, the workability refers to laser-via, desmear etching workability or the like.

That is, it is demanded a material for use in a flexible board without a base, in which the material has properties comparable with those of a prepreg of FR-4 or halogen-free FR4, in addition to the bending characteristics and variation of the thickness as the material itself.

An object of the present invention is to provide an epoxy-based thermosetting resin composition having a some degree of flexibility, capable of providing a thin film with insulation property, and exhibiting reliability and workability comparable with those of halogen-free FR-4.

Further, an object of the present invention is to provide a material for a flexible board using the above thermosetting resin composition.

Another object of the present invention is to provide an adhesive material for use in heat dissipation board superior in its adhesive strength with a metal such as pure aluminum, by applying the above resin composition.

Further, another object of the present invention is to provide a high density flexible build-up print wiring board, module board and heat dissipation board using them.

The present invention provides a thermosetting resin composition comprising:

(a1) a liquid epoxy resin;

(a2) a solid epoxy resin having a softening point of 125° C. or higher;

(b) an aromatic diamine compound comprising benzoate group and a main chain including polymethylene group;

(c) a solvent soluble polyimide resin having Tg of 200° C. or higher and a weight average molecular weight Mw of 50000 or smaller; and

(d) a phenoxy resin having Tg of 130° C. or higher.

A total of contents of (c) the solvent soluble polyamide resin and (d) the phenoxy resin is 15 weight parts or more and 150 weight parts or less provided that 100 weight parts are assigned to a total of contents of (a1) the liquid epoxy resin, (a2) the solid epoxy resin and (b) the aromatic diamine compound.

The present invention further provides a resin film in B-stage produced from the thermosetting resin composition.

The present invention further provides a metal foil and copper clad board each having the resin film in B-stage.

The present invention further provides a multi-layer build-up board produced by using the thermosetting resin composition as its interlayer insulating material.

In prior arts, for improving flexibility of an epoxy resin, it has been used a phenoxy resin, a thermoplastic resin or carboxyl group-modified rubber is used as its modifying agent to attain the improvement. According to these prior methods only, however, it has been very difficult to attain reliability and workability comparable with those of halogen-free FR-4.

According to the present invention, it is found that flexibility of an epoxy resin can be improved without deteriorating its reliability and workability, by providing a some degree of flexibility to a bone structure of a heat resistive solidifier and by adding both of specific phenoxy resin and solvent soluble polyimide resin.

Further, it is found that mutual solubility of resins during solidification is also important for realizing the unique characteristics of the resins in the resultant whole resin composition. It is further found that such effects can be obtained by selecting resin components so that melting of the resin components occurs continuously (including apparent melting state of the resin components).

Further, the inventive composition basically aims at improving adhesive property of the composition to an imide film, copper and metal base board materials (especially pure aluminum). It is found that this effect can be realized by the synergistic effects of adding both of the aromatic diamine solidifier having benzoate group and solvent soluble polyimide solidifier. The present invention was thus made.

### Embodiments of the Invention

((a1) A Liquid Epoxy Resin, and (a2) a Solid Epoxy Resin Having a Softening Point of 125° C. or Lower)

Both of (a1) and (a2) may be appropriately selected, as far as the epoxy resin includes two or more glycidyl groups. Preferably, the liquid epoxy resin includes bis-phenol A type epoxy resin, bis-phenol F type epoxy resin, novolak phenol type epoxy resin and naphthalene type epoxy resin. Further, the solid epoxy resin includes novolak phenol type epoxy resin, biphenyl type epoxy resin, naphthalene type epoxy resin and dicyclopentadiene type epoxy resin, or the like.

These epoxy resins may be used alone or in combination.

The softening point of the solid epoxy resin is made 125° C. or lower, because Tg of the phenoxy resin used as a modifying agent is made 130° C. or higher. Although it is difficult to directly apply the definition of a softening point to phenoxy resin, which is a polymer, it has been made clear experimentally that Tg can be used as an alternative index of the softening point of phenoxy resin. The object of the limitation of the softening point of the epoxy resin is that the epoxy resin is molten before the melting of the phenoxy resin layer during the solidifcation of the resin composition to obtain uniform solidified layer of the resin composition.

Further, both of the liquid and solid epoxy resins are used according to the following reasons. That is, the solid epoxy resin is preferably used so that properties of the solidified product of the inventive resin composition to those of FR-4 resin. It is, however, difficult to make the molten state of the resin composition uniform during the solidification. The epoxy resin in liquid state at an ambient temperature is thereby used so that the melting continuously takes place to realize the desired uniform molten state during the solidification process.

The viscosity of the liquid epoxy resin may preferably be 1.0 to 120 Pa·s, and may more preferably be 1.2 to 100 Pa·s at 25° C. It is provided that the viscosity is defined as a value obtained by measurement by means of E type viscometer.

The softening point of the solid epoxy resin is 125° C. or lower and may preferably be 100° C. or lower on the viewpoint of the present invention. However, the softening point of the epoxy resin may preferably be 50° C. or higher, on the viewpoint of obtaining the effects of the solid epoxy resin during the mixing with the liquid epoxy resin.

A ratio of the liquid and solid epoxy resins are to be decided on the viewpoint of the desired characteristics and control of the molten state. Therefore, the ratio is not necessarily limited. However, a ratio of the liquid epoxy resin may preferably be 20 to 50 weight parts provided that a total content of the liquid and solid epoxy resins is 100 weight parts.

### ((b) An Aromatic Diamine Compound Comprising Benzoate Group and a Main Chain Including Polymethylene Group)

The above aromatic diamine solidifier having an ester bond is superior in an adhesive strength with a polyimide film or a metal base such as aluminum base. In addition to this, polymethylene structure is introduced into the bone structure of the diamine solidifier so that it is possible to provide heat resistance as well as a some degree of flexibility to the bone structure of the epoxy resin.

Here, a number of methylene groups of the polymethylene group provided in the main chain may preferably be 3 or more and/or 16 or less.

Specifically, the solidifier includes trimethylene-bis(4-amino benzoate) (melting point is 122° C.), poly (tetra/3-methyl tetramethylene ether)glycol bis-(4-amino benzoate) (liquid), polytetramethylene oxide-di-p-amino benzoate; melting point is 15 to 60° C.) or the like.

Further, the melting point of this solidifier may preferably be 125° C. or lower according to the same reason as in the case of (a2) the solid epoxy resin.

According to the composition of the present invention, the added content of (b) the aromatic diamine compound may preferably be 0.95 to 1.50 in the term of active hydrogen equivalent number, provided that 1 (one) is assigned to a total of epoxy equivalent number of (a1) the liquid epoxy resin and epoxy equivalent number of (a2) the solid epoxy resin.

Here, each epoxy equivalent number of each of the epoxy resins is defined as follows.

Each epoxy equivalent number of each epoxy resin=(Weight(solid weight) of each epoxy resin in composition)/(Each epoxy equivalent of each epoxy resin)

Active hydrogen equivalent number of (b) the aromatic diamine compound is defined as follows.

Active hydrogen equivalent number of (b) aromatic diamine compound=(Weight of aromatic diamine compound in composition)/Active hydrogen equivalent number of aromatic diamine compound)

The active hydrogen equivalent number of the aromatic diamine compound provided that 1 (one) is assigned to a total of the epoxy equivalent numbers of the epoxy resins is defined as a ratio (dimensionless quantity) of the both. The ratio is therefore calculated according to the following formula.

(Active hydrogen equivalent number of the aromatic diamine compound)/(total of epoxy equivalent numbers of the epoxy resins)

### ((c) A Solvent Soluble Polyimide Resin Having Tg of 200° C. or Higher and a Weight Average Molecular Weight Mw of 50000 or Less)

(c) The solvent soluble polyimide resin is polyimide resin soluble in a specific organic solvent used for the production of the inventive composition. (c) The solvent soluble polyimide resin may preferably have a high Tg, a low C. T. E., superior film properties and superior adhesive properties. The weight average molecular weight (Mw) of the polyimide resin may preferably be 50000 or lower and more preferably be 35000 or lower. Further, the weight average molecular weight (Mw) of the polyimide resin may preferably be 20000 or higher and more preferably be 25000 or higher.

(c) The solvent soluble polyimide resin may preferably have phenyl indane structure. Further, (c) the polyimide resin may preferably be a soluble and fully imidized polyimide resin obtained by reacting diamino alkyl indane and tetracarboxylic dianhydride or its derivative. Here, diaminotrialkyl indane includes diaminotrimethyl indane and diamino triethyl indane. The derivative of tetracarboxylic dianhydride includes benzophenone tetracarboxylic dianhydride.

The soluble and fully imidized polyimide resin obtained by reacting diamino trimethyl phenyl indan and benzophenone tetracarboxylic dianhydride is shown in the following formula. It is further preferred a soluble and fully imidized polyimide resin obtained by reacting diamino trimethyl phenyl indane and tetracarboxylic dianhydride.

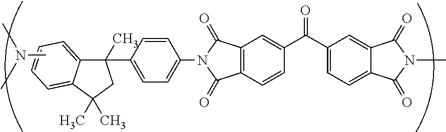

The solvent soluble polyimide resin, particularly the resin having phenyl indane structure, is superior in its adhesive strength with copper, an imide film, pure aluminum or the like. Further, Tg can be further improved by adding the solvent soluble polyimide resin into the resin composition, so that it is preferred on the viewpoint of assuring the reliability comparable with that of FR-4.

The inventive composition basically aims at improving the adhesive property with an imide film, copper and a metal base board material (especially pure aluminum). This effect is obtained by the synergistic effect of containing the aromatic diamine solidifier with benzoate group and the solvent soluble polyimide resin.

### ((d) Phenoxy Resin Having Tg of 130° C. or Higher)

Here, the phenoxy resin having Tg of 130° C. or higher is used for obtaining the connection reliability comparable with that of FR-4 level. That is, the connection reliability of FR-4 board is mainly judged by cold-heat cycle test between 125° C. and minus 65° C. Although phenoxy resin may often leave epoxy group as its end group and thus would possibly react with the solidifier, the phenoxy resin would mainly behave as a kind of a plasticizer due to its long molecular chain. Its Tg is thus considered to be a kind of index of the behavior derived from the viscoelasticity. Tg of 130° C. or higher is thus required for improving the connection reliability. That is, C. T. E. is one factor of the connection reliability and is considerably changed near its Tg. The influence of the change can be thereby reduced.

Tg (glass transition temperature) of the phenoxy resin is measured by DSC method. Although the kind of the phenoxy resin is not particularly limited, its resin bone structure may include BPA/BPS type, BP/BPS type, BP type, BPS type or the like and may preferably include heat resistant bone structure.

Further, the weight average molecular weight of the phenoxy resin may preferably be 10000 or larger.

Tg of the phenoxy resin may preferably be not higher than the molding temperature of the composition, because it is desirable that the phenoxy resin is uniformly molten during the solidification. Although the molding temperature is not necessarily limited, the inventive composition is epoxy resin type whose molding temperature is usually 180° C. or lower. In this case, Tg of the phenoxy resin may preferably be 180° C. or lower.

The phenoxy resin may be commercially available phenoxy resins including “YL6954BH30 (supplied by JER, Tg is 130° C.), “ERF-001M30” (supplied by Nippon Steel Chemical Co. LTD., Tg is 146° C.), “YX8100BH30” (supplied by JER, Tg is 150° C.) and the like.

Further, the phenoxy resin having Tg of 130° C. or higher and the solvent soluble polyimide resin are used at the same time. The synergistic effects are as follows. That is, the solvent soluble polyimide resin has a high softening point so that the softening of the polyimide resin would not occur during the melting process of the resins in the solidification (molding) of the composition. It is thus found that mutual solubility of the polyimide resin and the other components would tend to be insufficient. By adding both of the above resins, it is found that the softening of the polyimide resin can be facilitated so that all the components including the solvent soluble polyimide resin are subjected to pseudo-mutual soluble state according to the synergistic effects. The properties of the solidified product can thereby be made uniform.

Further, this uniform solidified product is also effective on the viewpoint of improving the workability. That is, in prior resin compositions providing flexibility, it has been observed ununiformity of laser processing and deviation in roughness of roughened desmear surface formed by desmear etching process.

The inventive solidified product can considerably improve the ununiformity of laser processing and deviation of roughness, so as to further improve the reliability.

A total of amounts of (c) the solvent soluble polyamide resin and (d) the phenoxy resin is 15 weight parts or more and 150 weight parts or less, provided that 100 weight parts are assigned to a total of amounts of (a1) the liquid epoxy resin, (a2) the solid epoxy resin and (b) the aromatic diamine compound. In the case that the total of (c) and (d) is less than 15 weight parts, the effects of improving the adhesion strength and flexibility of the composition is poor, and the total is made 15 weight parts or more. The total content of (c) and (d) may more preferably be 25 weight parts or more on this viewpoint. Further, in the case that the total amount is more than 150 weight parts, the fracture strength of the resultant film is lowered, and the total content is made 150 weight parts or less. The total content of (c) and (d) may preferably be 100 weight parts or less, more preferably be 50 weight parts or less and most preferably be 30 weight parts or less.

A ratio of (c) the solvent soluble polyimide resin and (d) phenoxy resin is not particularly limited. However, the content of (d) phenoxy resin may preferably be 60 weight parts or more provided that a total of contents of (c) solvent soluble polyimide resin and (d) phenoxy resin is 100 weight parts, for solidifying all the components including the solvent soluble polyimide resin in (pseudo) mutual soluble state. Further, on the viewpoint of obtaining the effects of (c) solvent soluble polyimide resin, the content of (d) phenoxy resin may preferably be 95 weight parts or less.

### ((e) Filler)

A filler may be, or may not be, added to the composition depending on the desired properties. Specifically, it is preferred alumina (thermal conductivity of 32 W/mK, aluminum nitride (thermal conductivity of 150 W/mK), boron nitride (thermal conductivity of 33 to 55 W/mK, silicon nitride (thermal conductivity of 20 W/mK) or the like as the filler. In the case that it is aimed at heat dissipation at a small film thickness, however, silica (thermal conductivity of 1.3 W/mK), aluminum oxide (thermal conductivity of 7.1 W/mK) or the like may be used despite that the thermal conductivity itself is low.

The addition of the filler is mainly for an adhesive for heat dissipation board and for improving thermal conduction of the adhesive. In such case, the selection of the filler is preferred.

Provided that 100 volume parts are assigned to a total of contents of (a1) the liquid epoxy resin, (a2) the solid epoxy resin, (b) the aromatic diamine compound, (c) the solvent soluble polyimide resin and (d) the phenoxy resin, the content of (e) the filler is decided depending on the desired properties, for example, thermal conductivity. Generally, the lower limit of the filler content is not particularly limited. On the viewpoint of utilizing the properties of the filler, the content of the filler may preferably be 5 weight parts or more and more preferably be 50 weight parts or more. Further, on the viewpoint of preserving the properties of the composition, the content of filler may preferably be 200 weight parts or lower. Further, as the heat dissipation property relates to the thermal conductivity and thickness, the content of the filler is preferably decided considering both of the thermal conductivity and thickness. As a specific thermal conductivity, 2 W/mK or more is often demanded as an organic type heat dissipation material. On the viewpoint, the content of the filler may preferably be 100 volume percent or more.

### (Additives)

Further, a hardening accelerator may be optionally added to the inventive composition. Hardening accelerators generally known may be used such as various kinds of imidazoles. The hardening accelerator is selected mainly depending on reaction speed and pot life.

For example, the hardening accelerator includes 2-methyl imidazole, 2-undecyl imidazole, 2-heptadecyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1,2-dimethyl imidazole, 1-cyanoethyl-2-ethyl-4-methyl imidazole, 1-cyanoethyl-2-undecyl imidazolium trimellitate, 1-cyanoethyl-2-phenyl imidazolium trimellitate, 2,4-diamino-6-[2′-methyl imidazolyl-(1′)]-ethyl-s-triazine, 2,4-diamino-6-[2′-undecyl imidazolyl-(1′)]-ethyl-s-triazine, 2,4-diamino-6-[2′-methyl imidazolyl-(1′)]-ethyl-s-triazine isocyanuric acid additive, 2-phenyl imidazole isocyanuric acid additive, 2-phenyl-4,5-dihydroxymethyl imidazole, 2-phenyl-4-methyl-5-hydroxymethyl imidazole, 2,3-dihydro-1H-pyro[1,2-a]benzimidazole, 4,4′-methylene bis(2-ethyl-5-methyl imidazole) and TPP.

A flame retarder may be added to the composition according to the present invention for imparting flame retarding property. Flame retarders free of halogen includes condensation type phosphoric esters, phosphazenes, polyphosphates, HCA (9,10-dihydro-9-oxa-10-phosphaphenanthrene-10-oxide) derivative, aluminum oxide or the like, although the kind of the flame retarder is not particularly limited.

Solvents usable in the resin composition according to the present invention is not particularly limited. The solvent may preferably a mixture of a solvent having a high boiling point such as NMP (N-methylpyrrolidone), γ-butyrolactone, or diethylene glycol monomethyl ether acetate and a solvent having a low or medium boiling point such as cyclohexanone, MEK (methyl ethyl ketone) or toluene. DMF (dimethyl formamide and DMAC (dimethyl acetoamide) may be further listed.

The thermosetting resin composition according to the present invention may be formed into a B-stage resin film. That is, the resin composition of the present invention is used to produce a thermosetting resin film in B-stage by means of a conventional process. For example, the resin composition is diluted with an appropriate organic solvent mixture to produce varnish. The varnish is then applied onto a polyethylene terephthalate film (PET film), optionally subjected to mold releasing process in advance, using a die coater and dried to obtain the thermosetting resin film in B-stage.

The thermosetting resin film in B-stage is a semi-cured film at a stage between A-stage (non-cured) and C-stage (fully cured).

Alternatively, the thermosetting resin composition according to the present invention may be applied onto a metal foil to produce a metal foil coated with an adhesive. Such metal foil includes a copper foil and aluminum foil subjected to surface roughening and more preferably be copper foil.

The resin film and RCC according to the present invention may be used for a printed wiring board having a non-through via hole such as a laser via as an HDI material of a build-up multi-layer board with a rigid core or FPC core.

### EXAMPLES

The present invention will be described further in detail.

### Example 1

It was produced a mixture of 98 weight parts of bis-phenol A type epoxy resin “EPICLON 850-S” (supplied by DIC Corporation, epoxy equivalent is 188), 147 weight parts of dicyclopentadiene type epoxy resin “HP-7200H” (supplied by DIC Corporation, epoxy equivalent is 283, softening point is 83° C.), 126 weight parts of “Elastomer 250P” (Polytetramethylene oxide-di-p-aminobenzoate, supplied by IHARA Chemical Co. Ltd., melting point is 60° C.), 100 weight parts of solvent soluble polyimide resin “Q-VR-X0163” (PI RESEARCH & DEVELOPMENT COMPANY LIMITED; Tg is 246° C., resin solid content is 20 weight percent), 303 weight parts of phenoxy resin “ERF-001M30” (supplied by Nippon Steel Chemical Co. Ltd., Tg is 146° C., solid content is 30 weight percent), and 18 weight parts of HCA. The resin solid content of the thus obtained mixture was adjusted at 40 weight percent to obtain a resin varnish.

### Example 2

It was produced a mixture of 111 weight parts of bis-phenol A type epoxy resin “EPICLON 850-8” (supplied by DIC Corporation, epoxy equivalent is 188), 167 weight parts of dicyclopentadiene type epoxy resin “HP-7200H” (supplied by DIC Corporation, epoxy equivalent is 283, softening point is 83° C.), 92 weight parts of “CUA-4” (trimethylene bis-(4-aminobenzoate; melting point is 122°, supplied by IHARA Chemical Co. Ltd.), 100 weight parts of solvent soluble polyimide resin “Q-VR-X0163” (PI RESEARCH & DEVELOPMENT COMPANY LIMITED; Tg is 246° C., resin solid content is 20 weight percent), 303 weight parts of phenoxy resin “ERF-001M30” (supplied by Nippon Steel Chemical Co. Ltd., Tg is 146° C., solid content is 30 weight percent), and 18 weight parts of HCA. The resin solid content of the thus obtained mixture was adjusted at 40 weight percent to obtain a resin varnish.

### Example 3

It was produced a mixture of 98 weight parts of bis-phenol A type epoxy resin “EPICLON 850-S” (supplied by DIC Corporation, epoxy equivalent is 188), 147 weight parts of dicyclopentadiene type epoxy resin “HP-7200H” (supplied by DIC Corporation, epoxy equivalent is 283, softening point is 83° C.), 126 weight parts of “Elastomer 250P” (Polytetramethylene oxide-di-p-aminobenzoate, supplied by IHARA Chemical Co. Ltd., melting point is 60° C.), 100 weight parts of solvent soluble polyimide resin “Q-VR-X0163” (PI RESEARCH & DEVELOPMENT COMPANY LIMITED; Tg is 246° C., resin solid content is 20 weight percent), 303 weight parts of phenoxy resin “YL6954BH30” (supplied by JER Corporation, Tg is 130° C., solid content is 30 weight percent), and 18 weight parts of HCA. The resin solid content of the thus obtained mixture was adjusted at 40 weight percent to obtain a resin varnish.

### Example 4

It was produced a mixture of 98 weight parts of bis-phenol A type epoxy resin “EPICLON 850-S” (supplied by DIC Corporation, epoxy equivalent is 188), 147 weight parts of dicyclopentadiene type epoxy resin “HP-7200H” (supplied by DIC Corporation, epoxy equivalent is 283, softening point is 83° C.), 126 weight parts of “Elastomer 250P” (Polytetramethylene oxide-di-p-aminobenzoate, supplied by IHARA Chemical Co. Ltd., melting point is 60° C.), 100 weight parts of solvent soluble polyimide resin “Q-VR-X0163” (PI RESEARCH & DEVELOPMENT COMPANY LIMITED; Tg is 246° C., resin solid content is 20 weight percent), 303 weight parts of phenoxy resin “YX8100BH30” (supplied by JER Corporation, Tg is 150° C., solid content is 30 weight percent), and 18 weight parts of HCA. The resin solid content of the thus obtained mixture was adjusted at 40 weight percent to obtain a resin varnish.

### Example 5

It was produced a mixture of 98 weight parts of bis-phenol A type epoxy resin “EPICLON 850-8” (supplied by DIC Corporation, epoxy equivalent is 188), 147 weight parts of dicyclopentadiene type epoxy resin “HP-7200H” (supplied by DIC Corporation, epoxy equivalent is 283, softening point is 830), 126 weight parts of “Elastomer 250P” (Polytetramethylene oxide-di-p-aminobenzoate, supplied by IHARA Chemical Co. Ltd., melting point is 60° C.), 100 weight parts of solvent soluble polyimide resin “Q-VR-XO163” (PI RESEARCH & DEVELOPMENT COMPANY LIMITED; Tg is 246° C., resin solid content is 20 weight percent), 303 weight parts of phenoxy resin “YX8100BH80” (supplied by JER Corporation, Tg is 150° C., solid content is 30 weight percent), 18 weight parts of HCA, and 1600 weight parts of spherical alumina powder with surface treatment. The resin solid content of the thus obtained mixture was adjusted at 75 weight percent to obtain a resin varnish.

### Comparative Example 1

It was produced a mixture of 108 weight parts of bis-phenol A type epoxy resin “EPICLON 850-S” (supplied by DIC Corporation, epoxy equivalent is 188), 155 weight parts of dicyclopentadiene type epoxy resin “HP-7200H” (supplied by DIC Corporation, epoxy equivalent is 283, softening point is 83° C.), 112 weight parts of BAPP (2,2-bis[4-(4-aminophenoxy)phenyl]propane, supplied by Wakayama Seika Kogyo Co. Ltd., melting point is 128° C.), 100 weight parts of solvent soluble polyimide resin “Q-VR-X0163” (PI RESEARCH & DEVELOPMENT COMPANY LIMITED; Tg is 246° C., resin solid content is 20 weight percent), 303 weight parts of phenoxy resin “ERF-001M30” (supplied by Nippon Steel Chemical Co. Ltd., Tg is 146° C., solid content is 30 weight percent), and 18 weight parts of HCA. The resin solid content of the thus obtained mixture was adjusted at 40 weight percent to obtain a resin varnish.

### Comparative Example 2

It was produced a mixture of 97 weight parts of bis-phenol A type epoxy resin “EPICLON 850-8” (supplied by DIC Corporation, epoxy equivalent is 188), 145 weight parts of dicyclopentadiene type epoxy resin “HP-7200H” (supplied by DIC Corporation, epoxy equivalent is 283, softening point is 83° C.), 213 weight parts of melamine-modified phenol novolak resin “ILA-7054” (supplied by DIC Corporation, hydroxyl group value is 125, resin solid content is 60 weight percent), 100 weight parts of solvent soluble polyimide resin “Q-VR-X0168” (PI RESEARCH & DEVELOPMENT COMPANY LIMITED; Tg is 246° C., resin solid content is 20 weight percent), 303 weight parts of phenoxy resin “ERF-001M30” (supplied by Nippon Steel Chemical Co. Ltd., Tg is 146° C., solid content is 30 weight percent), and 18 weight parts of HCA. The resin solid content of the thus obtained mixture was adjusted at 40 weight percent to obtain a resin varnish.

### Comparative Example 3

It was produced a mixture of 287 weight parts of cresol novolak type epoxy resin “N-695” (supplied by DIC Corporation, epoxy equivalent is 215, softening point is 98° C.), 134 weight parts of “Elastomer 250P” (Polytetramethylene oxide-di-p-aminobenzoate, supplied by IHARA Chemical Co.

Ltd., melting point is 60° C.), 100 weight parts of solvent soluble polyimide resin “Q-VR-X0163” (supplied by PI RESEARCH & DEVELOPMENT COMPANY LIMITED; Tg is 246° C., resin solid content is 20 weight percent), 303 weight parts of phenoxy resin “ERF-001M30” (supplied by Nippon Steel Chemical Co. Ltd., Tg is 146° C., solid content is 80 weight percent), and 18 weight parts of HCA. The resin solid content of the thus obtained mixture was adjusted at 40 weight percent to obtain a resin varnish.

### Comparative Example 4

It was produced a mixture of 98 weight parts of bis-phenol A type epoxy resin “EPICLON 850-S” (supplied by DIC Corporation, epoxy equivalent is 188), 147 weight parts of dicyclopentadiene type epoxy resin “HP-7200H” (supplied by DIC Corporation, epoxy equivalent is 283, softening point is 83° C.), 126 weight parts of “Elastomer 250P” (Polytetramethylene oxide-di-p-aminobenzoate, supplied by IHARA Chemical Co. Ltd., melting point is 60° C.), 870 weight parts of phenoxy resin “YX8100BH30” (supplied by JER Corporation, Tg is 150° C., solid content is 30 weight percent) and 18 weight parts of HCA. The resin solid content of the thus obtained mixture was adjusted at 40 weight percent to obtain a resin varnish.

### Comparative Example 5

It was produced a mixture of 97 weight parts of bis-phenol A type epoxy resin “EPICLON 850-S” (supplied by DIC Corporation, epoxy equivalent is 188), 145 weight parts of dicyclopentadiene type epoxy resin “HP-7200H” (supplied by DIC Corporation, epoxy equivalent is 283, softening point is 83° C.), 213 weight parts of melamine-modified phenol novolak resin “LA-7054” (supplied by DIC Corporation, hydroxyl group value is 125, resin solid content is 60 weight percent), 111 weight parts of carboxy-containing acrylonitrile-butadiene rubber “Nipor 1072” (supplied by ZEON Corporation) and 18 weight parts of HCA. The resin solid content of the thus obtained mixture was adjusted at 40 weight percent to obtain a resin varnish.

### Comparative Example 6

It was produced a mixture of 97 weight parts of bis-phenol A type epoxy resin “EPICLON 850-S” (supplied by DIC Corporation, epoxy equivalent is 188), 145 weight parts of dicyclopentadiene type epoxy resin “HP-7200H” (supplied by DIC Corporation, epoxy equivalent is 283, softening point is 83° C.), 213 weight parts of melamine-modified phenol novolak resin “LA-7054” (supplied by DIC Corporation, hydroxyl group value is 125, resin solid content is 60 weight percent), 111 weight parts of phenoxy resin “YP-55” (supplied by Tohto Kasei Co., Ltd., Tg is 84° C.) and 18 weight parts of HCA. The resin solid content of the thus obtained mixture was adjusted at 40 weight percent to obtain a resin varnish.

### Comparative Example 7

It was produced a mixture of 97 weight parts of bis-phenol A type epoxy resin “EPICLON 850-5” (supplied by DIC Corporation, epoxy equivalent is 188), 145 weight parts of dicyclopentadiene type epoxy resin “HP-7200H” (supplied by DIC Corporation, epoxy equivalent is 288, softening point is 83° C.), 213 weight parts of melamine-modified phenol novolak resin “LA-7054” (supplied by DIC Corporation, hydroxyl group value is 125, resin solid content is 60 weight percent), 100 weight parts of solvent soluble polyimide resin “Q-VR-X0168” (PI ESEARCH & DEVELOPMENT COMPANY LIMITED; Tg is 246° C., resin solid content is 20 weight percent), 303 weight parts of phenoxy resin “YX8100BH30” (supplied by JER Corporation, Tg is 150° C., solid content is 30 weight percent), 18 weight parts of HCA, and 1600 weight parts of spherical alumina powder with surface treatment. The resin solid content of the thus obtained mixture was adjusted at 75 weight percent to obtain a resin varnish.

Each of the above described resin varnishes was sufficiently dispersed with a three roll mill in the case that the varnish contained the filler or rubber.

The varnish was applied onto a polyethylene terephthalate film (PET film) having a thickness of 25 μm and with mold releasing treatment, by means of a die coater, and dried at 120° C. to produce a thermosetting resin film (A) in B-stage having a thickness of 51 μm. The volatile matter content of the film was adjusted at 0.5 weight percent. A polyethylene film (PE film) was laminated on the resin film as a protective film to obtain a laminate.

The thus obtained laminate was laminated on a copper foil having a thickness of 18 μm without surface treatment and charged in a vacuum press to heat the laminate at 180° C. for 120 minutes at a pressure of 1 MPa and a degree of vacuum of 5 Torr to obtain a molded body (Molded body (1)).

Similarly, the thus obtained laminate was laminated on a copper foil with processing feet and charged in a vacuum press to heat the laminate at 180° C. for 120 minutes at a pressure of 1 MPa and a degree of vacuum of 5 Torr to obtain a molded body (Molded body (2)).

On the other hand, a circuit and through hole were formed in an all polyimide copper clad board having a thickness of 25 μm (thickness of copper foil is 18 μm), and the conductor was treated with black copper oxide. The protective film was peeled off from the film (A), which was then laminated on both surfaces of the board. Further, copper foils were then laminated on the both surfaces of the board and then contained in a vacuum press. The board was then heated and pressurized at 18° C. for 90 minutes at a pressure of 1 MPa (vacuum degree was 1 Torr). The board was cooled, drawn out, and then subjected to conformal mask process by CO2 laser to form a blind via with a predetermined hole size.

The molded body was treated with permanganate desmear solution for surface roughening and for removing and dissolving residual resin on the bottom of the via hole. 0.5 μm of electroless plating of copper and 20 μm of electroplating of copper were formed on the laminate, which was then subjected to afterbaking at 180° C. for 30 minutes. A circuit was formed thereon to obtain a 4-layer build-up printed wiring board (I) (PWB(I)) having one build-up layers on both sides of the board, respectively.

Tables 1 and 2 show the parameters of the above examples, respectively. Tables 3 and 4 show the results of evaluation of properties in the above examples, respectively.

Further, “PWB(II)” shown in table 2 is a test pattern board based on JPCA-HD01 produced according to the procedure of producing the PWB (I). PWB(II): test pattern board based on JPCA-HD01 produced according to the procedure of producing the PWB (1).
1): AL1060 was used instead of the copper foil in the molded body (2).
2): A polyimide film was used instead of the copper foil in the molded body (2).

(0076)

### (Reliability)

Reliability was evaluated by “JPCA-BU01”.

(a) Thermal shock test: A sample was held at 125° C. for 30 minutes and then at −65° C. for 30 minutes in a single cycle. The number of the cycles performed is shown in table 2.

(b) High temperature and high humidity bias test: 85° C., 85% RH DC=30V (measured in a bath)

Laser workability is judged from hole size, top size/bottom size, and an amount of resin left on a bottom of a via after laser processing by CO2 laser.

Desmear etching workability is judged from an amount of left resin, surface roughness and uniformity of roughened surface after desmear etching using permanganate.

TABLE 1

| Inventive Examples | 1 | 2 | 3 | 4 | 5 |
|---|---|---|---|---|---|
| (a1) Liquid epoxy resin | 98 | 111 | 98 | 98 | 98 |
| (a2) Solid epoxy resin with a softening point of 125° C. | 147 | 167 | 147 | 147 | 147 |
| (b) Aromatic diamine compound having benzoate | 126 | 92 | 126 | 126 | 126 |
| group and main chain with polymethylene group | | | | | |
| Other aromatic diamine solidifier | — | — | — | — | — |
| Novolak phenol resin solidifier | — | — | — | — | — |
| (c) Solvent soluble polyimide resin of | 20 | 20 | 20 | 20 | 20 |
| Tg ≧ 200° C., Mw ≦ 50000 | | | | | |
| (d) Phenoxy resin of Tg ≧ 130° C. | 90.9 | 90.9 | 90.9 | 90.9 | 90.9 |
| Phenoxy resin of Tg < 130° C. | — | — | — | — | — |
| Carboxy-containing acrylonitrile-butadiene rubber | — | — | — | — | — |
| (e) filler (Spherical alumina) | — | — | — | — | 1600 |
| Other (Flame Retardant) | 18 | 18 | 18 | 18 | 18 |
| (a1)/(a1) + (a2) [Weight parts] | 40/100 | 40/100 | 40/100 | 40/100 | 40/100 |
| Active hydrogen equivalent number of (b)/ | 0.99 | 0.99 | 0.99 | 0.99 | 0.99 |
| Epoxy equivalent number of (a1) + (a2) | | | | | |
| (c) + (d)/(a1) + (a2) + (b) [Weight parts] | 29.9/100 | 30.0/100 | 29.9/100 | 29.9/100 | 29.9/100 |
| (e)/(a1) + (a2) + (b) + (c) + (d) [Volume parts] | 0/100 | 0/100 | 0/100 | 0/100 | 105/100 |

TABLE 2

| Comparative Examples | 1 | 2 | 3 | 4 | 5 | 6 | 7 |
|---|---|---|---|---|---|---|---|
| (a1) Liquid epoxy resin | 103 | 97 | — | 98 | 98 | 98 | 97 |
| (a2)Solid epoxy resin with softening point of 125° C. or lower | 155 | 145 | 237 | 147 | 147 | 147 | 145 |
| (b) Aromatic diamine compound having benzoate group and | — | — | 134 | 126 | — | — | — |
| Other aromatic diamine solidifier | 112 | — | — | — | — | — | — |
| Novolak phenol resin solidifier | — | 127.8 | — | — | 127.8 | 127.8 | 127.8 |
| (c) Solvent soluble polyimide resin of Tg ≧ 200° C., Mw ≦ 50000 | 20 | 20 | 20 | — | — | — | 20 |
| (d) Phenoxy resin of Tg ≧ 130° C. | 90.9 | 90.9 | 90.9 | 111 | — | — | 90.9 |
| Phenoxy resin of Tg < 130° C. | — | — | — | — | — | 111 | — |
| Carboxy-containing acrylonitrile-butadiene rubber | — | — | — | — | 111 | — | — |
| (e) filler (Spherical alumina) | — | — | — | — | — | — | 1600 |
| Other (Flame Retardant) | 18 | 18 | 18 | 18 | 18 | 18 | 18 |
| (a1)/(a1) + (a2) [Weight parts] | — | — | 0/100 | 40/100 | — | — | — |
| Active hydrogen equivalent number of (b)/ | — | — | 1.0 | 0.99 | — | — | — |
| Epoxy equivalent number of (a1) + (a2) | | | | | | | |
| (c) + (d)/(a1) + (a2) + (b) [Weight parts] | — | — | 29.9/100 | 29.9/100 | — | — | — |
| (e)/(a1) + (a2) + (b) + (c) + (d) [Volume parts] | — | — | 0/100 | 0/100 | — | — | 105/100 |

TABLE 3

| Examples | | | 1 | 2 | 3 | 4 | 5 |
|---|---|---|---|---|---|---|---|
| Folding endurance (MIT R = 0.38) | | Molded body (1) Etching | 460 | 490 | 470 | 455 | 20 |
| Tg(° C.): TMA Method | | Molded body (1) Etching | 135 | 154 | 131 | 132 | 140 |
| C.T.E | α1 | Molded body (1) Etching | 68 | 63 | 65 | 63 | 28 |
| (ppm/° C.) | α2 | | 186 | 183 | 175 | 175 | 92 |
| Peel strength | Copper foil (18 μm) | Molded body (2) | 1.2 | 1.2 | 1.2 | 1.2 | 1.1 |

| (kN/m) | Pure aluminum (AL1060 20 μm) *1) | | | 1.2 | 1.2 | 1.2 | 1.2 | 1.2 |
|---|---|---|---|---|---|---|---|---|
| | Polyimide film (25 μm) *2) | | | Base | Base | Base | Base | 1.2 |
| | | | | fractured | fractured | fractured | fractured | |
| Film Properties | Young's modulus | Molded body (1) Etching | | 1.6 | 1.7 | 1.6 | 1.6 | 8.5 |
| | (GPa) | | | | | | | |
| | Fracture Strength | | | 75 | 83 | 85 | 75 | 95 |
| | (MPa) | | | | | | | |
| | Elongation (%) | | | 9.8 | 8.2 | 9.8 | 9.8 | 2.5 |
| Resistance to flame UL94 | | Molded body (1) Etching | | VTM-0 | VTM-0 | HB | HB | HB |
| | | With core *2) | | VTM-0 | VTM-0 | VTM-0 | VTM-0 | VTM-0 |
| | | (25 μm Polyimide) | | | | | | |
| Thermal conductiveity (W/mK) | | Molded body (1) Etching | | 0.2 | 0.2 | 0.2 | 0.2 | 2.2 |
| Laser flash method | | | | | | | | |
| Reliability | Connection Reliability | PWB (II) | (a) | >500 | >500 | >500 | >500 | >500 |
| (a: cycles) | Insulation Reliability | | (b) | >1,000 | >1,000 | >1,000 | >1,000 | >1,000 |
| (b: hrs) | | | | | | | | |

| | | | | | | |
|---|---|---|---|---|---|---|
| CO2 Laser workability | PWB(I) | ◯ | ◯ | ◯ | ◯ | Δ |
| Desmear Etching workability | PWB(I) | ◯ | ◯ | ◯ | ◯ | Δ |

TABLE 4

| Comparative Examples | | | 1 | 2 | 3 | 4 | 5 | 6 | 7 |
|---|---|---|---|---|---|---|---|---|---|
| Folding endurance (MIT R = 0.38) | | Molded body (1) Etching | 395 | 380 | 425 | 356 | 400 | 385 | 10 |
| Tg(° C.): TMA Method | | Molded body (1) Etching | 149 | 150 | 142 | 119 | 75 | 90 | 150 |
| C.T.E | α1 | Molded body (1) Etching | 62 | 63 | 65 | 63 | 85 | 75 | 27 |
| (ppm/° C.) | α2 | | 178 | 180 | 177 | 198 | 201 | 197 | 93 |
| Peel strength | Copper foil (18 μm) | Molded body (2) | 1.2 | 1.2 | 1.2 | 1.2 | 1.4 | 1.2 | 1.1 |

| (kN/m) | Pure aluminum (AL1060 20 μm) *1) | | | 0.4 | 0.3 | 1.2 | 0.6 | 0.3 | 0.3 | 0.3 |
|---|---|---|---|---|---|---|---|---|---|---|
| | Polyimide film (25 μm) *2) | | | 0.6 | 0.5 | Base | 0.8 | Base | Base | 0.5 |
| | | | | | | Fracture | | Fracture | Fracture | |
| Film Properties | Young's modulus | Molded body (1) Etching | | 1.8 | 1.8 | 1.8 | 1.7 | 1.4 | 1.5 | 8.2 |
| | (GPa) | | | | | | | | | |
| | Fracture Strength | | | 80 | 85 | 65 | 78 | 55 | 65 | 98 |
| | (MPa) | | | | | | | | | |
| | Elongation (%) | | | 7.5 | 7.8 | 5.8 | 8.0 | 8.8 | 7.8 | 2.0 |
| Resistance to flame UL94 | | Molded body (1) Etching | | VTM-0 | VTM-0 | VTM-0 | Not | Not | Not | HB |
| | | | | | | | HB | HB | HB | |
| | | With core *2) | | VTM-0 | VTM-0 | VTM-0 | HB | HB | HB | VTM-0 |
| | | (25 μm Polyimide) | | | | | | | | |
| Thermal conductiveity (W/mK) | | Molded body (1) Etching | | 0.2 | 0.2 | 0.2 | 0.2 | 0.2 | 0.2 | 2.1 |
| Laser flash method | | | | | | | | | | |
| Reliability | Connection Reliability | PWB (II) | (a) | 400 | 400 | 480 | 450 | 220 | 250 | 450 |
| (a: cycles) | Insulation Reliability | | (b) | >1,000 | >1,000 | >1,000 | >1,000 | 800 | 900 | >1,000 |
| (b: hrs) | | | | | | | | | | |

| | | | | | | | | |
|---|---|---|---|---|---|---|---|---|
| CO2 Laser workability | PWB(I) | ◯ | ◯ | Δ | ◯ | X | Δ | Δ |
| Desmear Etching workability | PWB(I) | ◯ | ◯ | Δ | ◯ | X | Δ | Δ |

As described above, the present invention provides an epoxy-based thermosetting resin composition capable of providing a film which is flexible, heat resistant and exhibits a high adhesive strength and reliability. The inventive resin composition can be thus applicable for a high density flexible build-up print wiring board, a high density thin build-up print wiring board and a heat dissipation board. The thus obtained print wiring board can be used for mobile phones, LED boards and the like.

Further, for the reference, the reliability data of “FR-4” material and “FR-4 resin” corresponding to those shown in the tables are as follows. It is clearly proved that the reliability data of the inventive materials are comparable with those of FR-4.

(a) >500

(b) >1,000

1. A thermosetting resin composition comprising:
(a1) a liquid epoxy resin;
(a2) a solid epoxy resin having a softening point of 125° C. or lower;
(b) an aromatic diamine compound comprising benzoate group and a main chain comprising polymethylene group;
(c) a solvent soluble polyimide resin having Tg of 200° C. or higher and a weight average molecular weight Mw of 50000 or smaller; and
(d) a phenoxy resin having Tg of 130° C. or higher;
wherein a total of contents of said solvent soluble polyamide resin and said phenoxy resin is 15 weight parts or more and 150 weight parts or less provided that 100 weight parts are assigned to a total of contents of said liquid epoxy resin, said solid epoxy resin and said aromatic diamine compound.

2. The resin composition of claim 1, wherein said solvent soluble polyamide resin comprises a soluble polyimide resin comprising phenyl indane structure, and wherein said soluble polyimide resin is fully imidized.

3. The resin composition of claim 1, further comprising:
(e) a filler, wherein said filler comprises one or more material selected from the group consisting of alumina, aluminum nitride, boron nitride, silica and aluminum hydroxide.

4. A resin film in B-stage produced from the composition of claim 1.

5. A metal foil comprising a layer comprising said resin film in B-stage of claim 4.

6. A copper clad board obtained by molding said resin film in B-stage of claim 4 and a metal foil and then solidifying said resin film.

7. A multi-layer build-up board comprising an interlayer insulation material comprising said thermosetting resin composition of claim 1.
